(19) United States
(12) Patent Application Publication
(10) Pub. No.: US 2025/0131095 A1
(43) Pub. Date: Apr. 24, 2025

(54) FLASH DEVICE SWITCHING METHOD AND APPARATUS, COMPUTER DEVICE, AND STORAGE MEDIUM

(71) Applicant: Suzhou MetaBrain Intelligent Technology Co., Ltd., Suzhou (CN)

(72) Inventors: Shouying JIANG, Suzhou (CN); Bing WANG, Suzhou (CN); Fanyi YAO, Suzhou (CN); Zhengchuan CHEN, Suzhou (CN); Yuzhong ZHANG, Suzhou (CN)

(21) Appl. No.: 18/983,961

(22) Filed: Dec. 17, 2024

Related U.S. Application Data
(63) Continuation of application No. PCT/CN2023/093611, filed on May 11, 2023.

(30) Foreign Application Priority Data
Nov. 29, 2022 (CN) 202211507724.6

(51) Int. Cl. G06F 21/57; G06F 21/64

(52) U.S. Cl. CPC G06F 21/575; G06F 21/572; G06F 21/64

(57) ABSTRACT

The present application relates to a Flash device switching method and apparatus, a computer device, and a storage medium. The method includes: when verification for a staging area, an active area, and a recovery area in a first flash device Flash corresponding to a first basic input/output system (BIOS) by a complex programmable logic device (CPLD) is passed, acquiring a power-on startup command of a server; performing power-on startup of the server according to the power-on startup command of the server; when the power-on startup of the server is not successful, triggering the CPLD to perform a recovery operation; and after the recovery operation of the CPLD fails, notifying the CPLD to switch the first flash device Flash to a second flash device Flash corresponding to a second BIOS.

### CROSS-REFERENCE TO RELATED APPLICATIONS

This application is a continuation of International Application No. PCT/CN2023/093611, filed May 11 2023, which claims priority to Chinese Patent Application No. 202211507724.6, entitled “FLASH DEVICE SWITCHING METHOD AND APPARATUS, COMPUTER DEVICE, AND STORAGE MEDIUM”, filed to China National Intellectual Property Administration on Nov. 29, 2022. The contents of International Application No. PCT/CN2023/093611 and Chinese Patent Application No. 202211507724.6 are incorporated herein by reference in their entireties.

### FIELD

The present application relates to the technical field of hardware, and particularly to a Flash device switching method and apparatus, a computer device, and a storage medium.

### BACKGROUND

In today's era, scientific and technological advancements are progressing rapidly. Particularly, the server product technology is in a leading position in the field of science and technology relying on its powerful computing ability, good compatibility, strong security, reliable operation stability, and other advantages. Many manufacturers work hard on the stability and verification security of the server, especially adding the platform firmware resilience (PFR) server. Because of the rich internal verification module, the PFR function might well avoid the risk of firmware tampering.

The inventors have realized that the current PFR server has only one flash device Flash, and when there is a problem or damage to the flash device Flash, the PFR server may fail to run normally or experience downtime, and the PFR server might not be booted up normally.

### SUMMARY

The present application provides a Flash device switching method and apparatus, a computer device, and a storage medium.

A Flash device switching method is provided, being applied to a server, the server including a complex programmable logic device (CPLD), a first basic input/output system (BIOS), and a second BIOS, where the first BIOS and the second BIOS include corresponding flash devices Flash, and the flash device Flash includes a staging area, an active area, and a recovery area, where the method includes:
when verification for the staging area, the active area, and the recovery area in a first flash device Flash corresponding to the first BIOS by the CPLD is passed, acquiring a power-on startup command of the server;
performing power-on startup of the server according to the power-on startup command of the server;
when the power-on startup of the server is not successful, triggering the CPLD to perform a recovery operation; and
after the recovery operation of the CPLD fails, notifying the CPLD to switch the first flash device Flash to a second flash device Flash corresponding to the second BIOS.

In one or more embodiments, the when verification for the staging area, the active area, and the recovery area in a first flash device Flash corresponding to the first BIOS by the CPLD is passed, acquiring a power-on startup command of the server includes:
invoking the CPLD to verify whether the staging area, the active area, and the recovery area in the first flash device Flash corresponding to the first BIOS are passed or not through hash values Hash; and
when the verification is passed, generating the power-on startup command of the server through the CPLD.

In one or more embodiments, the invoking the CPLD to verify whether the staging area, the active area, and the recovery area in the first flash device Flash corresponding to the first BIOS are passed or not through hash values Hash includes:
invoking the CPLD to acquire area data corresponding to the corresponding staging area, active area, and recovery area from the first flash device Flash;
invoking the CPLD to obtain corresponding reference area hash values by calculating according to the area data;
invoking the CPLD to acquire area hash values corresponding to the corresponding staging area, active area, and recovery area from the first flash device Flash; and
invoking the CPLD to determine whether the verification for the staging area, the active area, and the recovery area is passed or not according to the area hash values and the reference area hash values.

In one or more embodiments, the invoking the CPLD to obtain corresponding reference area hash values by calculating according to the area data includes:
invoking the CPLD to acquire a key; and
invoking the CPLD to calculate according to the key and the area data to obtain the corresponding reference area hash values.

In one or more embodiments, the invoking the CPLD to acquire area hash values corresponding to the corresponding staging area, active area, and recovery area from the first flash device Flash includes:
invoking the first flash device Flash to acquire the area data and signature data corresponding to the staging area, the active area, and the recovery area; and
invoking the first flash device Flash to obtain the corresponding area hash values by calculating according to the area data and the signature data corresponding to the staging area, the active area, and the recovery area.

In one or more embodiments, the above-mentioned method further includes:
acquiring first area data corresponding to the staging area through the first flash device Flash;
acquiring first signature data corresponding to the staging area through the first flash device Flash; and
obtaining the area hash value corresponding to the staging area by calculating through the first flash device Flash according to the first area data and the first signature data.

In one or more embodiments, the above-mentioned method further includes:
acquiring second area data corresponding to the active area through the first flash device Flash;
acquiring second signature data corresponding to the active area through the first flash device Flash; and
obtaining the area hash value corresponding to the active area by calculating through the first flash device Flash according to the second area data and the second signature data.

In one or more embodiments, the above-mentioned method further includes:
acquiring third area data corresponding to the recovery area through the first flash device Flash;
acquiring third signature data corresponding to the recovery area through the first flash device Flash; and
obtaining the area hash value corresponding to the recovery area by calculating through the first flash device Flash according to the third area data and the third signature data.

In one or more embodiments, the invoking the CPLD to determine whether the staging area, the active area, and the recovery area are passed or not according to the area hash values and the reference area hash values includes:
when invoking the CPLD to determine that the staging area, the active area, and the recovery area are matched according to the area hash values and the reference area hash values, determining that the verification is passed.

In one or more embodiments, the performing power-on startup of the server according to the power-on startup command of the server includes:

performing the power-on startup of the server according to the power-on startup command of the server, and running a main program on the server.

In one or more embodiments, the when the power-on startup of the server is not successful, triggering the CPLD to perform a recovery operation includes:
acquiring a startup time of the power-on startup of the server;
when the startup time exceeds a preset startup time, booting up a watchdog program of the first BIOS, and triggering the server to perform a reboot operation;
acquiring the number of operations of the server performing reboot; and
when the number of operations exceeds a preset number of operations, invoking the first BIOS to pull down a level signal corresponding to general-purpose input/output (GPIO), and triggering the CPLD to perform the recovery operation.

In one or more embodiments, the triggering the CPLD to perform a recovery operation includes:
acquiring a recovery area hash value corresponding to the recovery area in the first flash device Flash through the CPLD; and
replacing an active area hash value corresponding to the active area in the first flash device Flash with the recovery area hash value through the CPLD.

In one or more embodiments, the after the recovery operation of the CPLD fails, notifying the CPLD to switch the first flash device Flash to a second flash device Flash corresponding to the second BIOS includes:
acquiring the number of recovery operations of the CPLD; and
when the number of recovery operations exceeds a preset number, notifying the CPLD through an Espi protocol to switch the first flash device Flash to the second flash device Flash corresponding to the second BIOS.

In one or more embodiments, the server, the CPLD, the first BIOS, and the second BIOS all have a PFR function.

A Flash device switching apparatus is provided, being applied to a server, the server including a CPLD, a first BIOS, and a second BIOS, where the first BIOS and the second BIOS include corresponding flash devices Flash, and the flash device Flash includes a staging area, an active area, and a recovery area, where the apparatus includes:
a verification module, configured to, when verification for the staging area, the active area, and the recovery area in a first flash device Flash corresponding to the first BIOS by the CPLD is passed, acquire a power-on startup command of the server;
a power-on module, configured to perform power-on startup of the server according to the power-on startup command of the server;
a triggering module, configured to, when the power-on startup of the server is not successful, trigger the CPLD to perform a recovery operation; and
a switching module, configured to, after the recovery operation of the CPLD fails, notify the CPLD to switch the first flash device Flash to a second flash device Flash corresponding to the second BIOS.

A computer device is provided, including a memory and one or more processors, the memory having stored therein computer-readable instructions which, when executed by the one or more processors, cause the one or more processors to implement the steps of the above-mentioned Flash device switching method.

One or more non-volatile computer-readable storage media is provided, storing computer-readable instructions which, when executed by one or more processors, cause the one or more processors to perform the steps of the above-mentioned Flash device switching method.

The details of one or more embodiments of the present application are set forth in the accompanying drawings and the description below. Other features and advantages of the present application will be apparent from the description, drawings, and claims.

### BRIEF DESCRIPTION OF THE DRAWINGS

FIG. 1 is a schematic flowchart of a Flash device switching method according to one or more embodiments of the present application;

FIG. 2 is a schematic flowchart of verification steps of a CPLD according to one or more embodiments of the present application;

FIG. 3 is a schematic flowchart of verification steps of a CPLD according to one or more embodiments of the present application;

FIG. 4 is a schematic flowchart of calculation steps of reference area hash values according to one or more embodiments of the present application;

FIG. 5 is a schematic flowchart of acquisition steps of area hash values according to one or more embodiments of the present application;

FIG. 6 is a schematic flowchart of a Flash device switching method according to one or more embodiments of the present application;

FIG. 7 is a schematic flowchart of a Flash device switching method according to one or more embodiments of the present application;

FIG. 8 is a schematic flowchart of a Flash device switching method according to one or more embodiments of the present application;

FIG. 9 is a schematic flowchart of an operation method of a CPLD according to one or more embodiments of the present application;

FIG. 10 is a schematic flowchart of an operation method of a CPLD according to one or more embodiments of the present application;

FIG. 11 is a schematic flowchart of a flash device Flash switching method according to one or more embodiments of the present application;

FIG. 12 is a block diagram of a structure of a Flash device switching apparatus according to one or more embodiments of the present application; and

FIG. 13 is an internal structural diagram of a computer device according to one or more embodiments of the present application.

FIG. 14 is a schematic diagram of a server according to one or more embodiments of the present application.

### DETAILED DESCRIPTION

In order to make the object, technical solutions, and advantages of the present application clearer, the present application is further described in detail below in conjunction with the accompanying drawings and embodiments. It should be understood that the specific embodiments described herein are for the sole purpose of explaining the present application and are not intended to limit the present application.

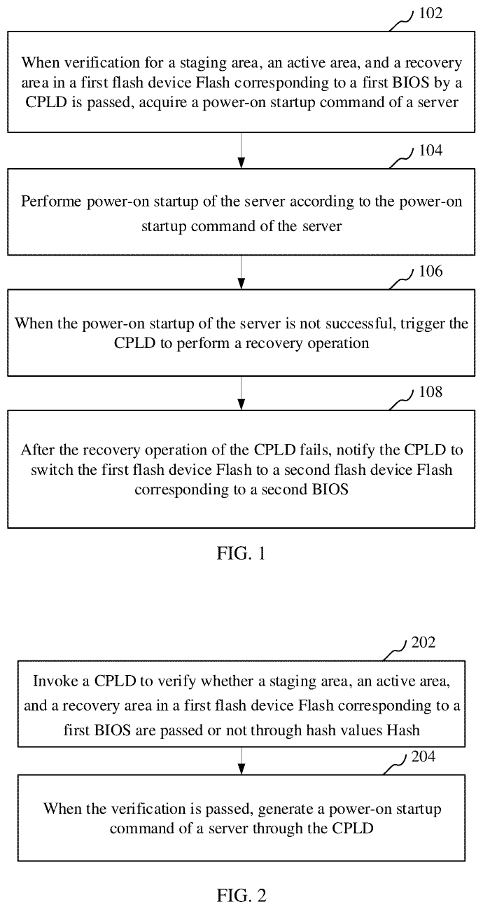

In an embodiment, as shown in FIG. 1, a Flash device switching method is provided. The method is applied to a server as an example for explanation. The server includes a controller, a first BIOS, and a second BIOS. The first BIOS and the second BIOS include corresponding flash devices Flash, and the flash device Flash includes a staging area, an active area, and a recovery area. In an embodiment, the controller includes at least a complex programmable logic device (CPLD) and a Microcontroller Unit (MCU).

In an embodiment, as shown in FIG. 14, and FIG. 14 illustrates a schematic of a server for one or more embodiments of the present application. The CPLD is part of the hardware on the server. Typically, the CPLD is connected to the BIOS through circuitry and interfaces on the motherboard. For example, the CPLD may communicate with the BIOS over a specified bus to transmit hardware status information or receive control commands. The Flash is a rewritable memory integrated circuit used to store firmware of the BIOS. The BIOS (Basic Input/Output System) is a basic, but fully functional, component of a computer motherboard. It is a programmable integrated circuit used to control the basic functions of the computer and to boot the system.

When the server is powered on, CPLD will verify the three storage areas in the first flash corresponding to the first BIOS, i.e., staging area, active area, and recovery area, and after the verification passes, it will control the startup of the first flash corresponding to the first BIOS, and then power on the server according to the server's power-on code. If the verification fails, the CPLD will try to recover again, and if the recovery fails, the CPLD will directly switch the first flash corresponding to the first BIOS to the second flash corresponding to the second BIOS, and then the CPLD carries out verification of the three storage areas of the second flash, and controls the startup of the second flash of the second BIOS after the verification succeeds, and then powers up the server according to the server power-on code. server power-on code.

In an embodiment, the method includes the following steps.

At step 102, when verification for the staging area, the active area, and the recovery area in a first flash device Flash corresponding to the first BIOS by the CPLD is passed, a power-on startup command of the server is acquired.

The server has a PFR function, and the PFR adopts a hardware-based solution, which provides a brand-new method for protecting the firmware in the server, and might comprehensively prevent attacks on all the firmware in the server. The PFR addresses vulnerabilities for enterprise servers that contain multiple underlying processing assemblies, each with its own firmware. The firmware may be hacked, e.g., by embedding malicious codes in the flash memory of the assembly that might easily escape standard system detection means, resulting in permanent damage to the system.

The PFR uses a CPLD as the core of the whole PFR technology and defines a special pre-boot state T minus 1 (T−1). After the system is powered on, a T−1 stage is first entered. At this time, all other firmware (BIOS, etc.) with possible bootup interfaces are in a reset state, and only when the PFR CPLD is powered on, the PFR CPLD first verifies the BIOS Flash. Therefore, the server with the PFR may include the CPLD, the first BIOS, and the second BIOS, where the first BIOS and the second BIOS include corresponding flash devices Flash, and the flash device Flash includes the staging area Staging, the active area Active, and the recovery area Recovery.

The staging area Staging is a temporary buffer region for upgrading, the active area Active stores uncompressed and directly executed firmware, and the recovery area Recovery stores compressed backup files.

In some embodiments, before power-on startup of the server is performed, the CPLD might verify the staging area, the active area, and the recovery area in the first flash device Flash corresponding to the first BIOS, and only after the verification is successful, the server might be powered on.

At step 104, power-on startup of the server is performed according to the power-on startup command of the server.

After the verification for the staging area, the active area, and the recovery area in the first flash device Flash corresponding to the first BIOS by the CPLD is successful, the CPLD may be triggered to generate the power-on startup command of the server, and the server performs power-on startup according to the power-on startup command of the server.

At step 106, when the power-on startup of the server is not successful, the CPLD is triggered to perform a recovery operation.

When the server performs the power-on startup operation, there are two situations for the server at this time. One is that the power-on startup of the server is successful, indicating that the server has not encountered any problem and runs successfully. The other is that power-on startup of the server is not successful, indicating that the server encounters a problem during running, e.g., downtime. Thus, when the power-on startup of the server is not successful, the CPLD may perform a recovery operation.

The recovery operation performed by the CPLD may be a recovery operation performed on the active area Active in the first flash device Flash of the first BIOS, for example, a recovery operation performed on the active area Active by the recovery area Recovery in the first flash device Flash.

At step 108, after the recovery operation of the CPLD fails, the CPLD is notified to switch the first flash device Flash to a second flash device Flash corresponding to the second BIOS.

When the CPLD performs the recovery operation, there will also be two situations at this time. One is that the recovery operation of the CPLD is successful, indicating that the server may run successfully through the recovery of the CPLD, and the other is that the recovery operation of the CPLD fails, indicating that the server might not be successful through the recovery of the CPLD. Therefore, in order to ensure the normal running of the server, the successful start-up operation of the server may be ensured by switching the flash devices Flash.

In some embodiments, after the recovery operation of the CPLD fails, a command may be sent to the CPLD so as to notify the CPLD to switch the first flash device Flash to the second flash device Flash corresponding to the second BIOS. Thus, it is possible to cope with the situation that any one of the flash devices Flash is damaged so that the server might not run normally.

In the above-mentioned Flash device switching method, before the power-on startup of the server is performed, when the verification for the staging area, the active area, and the recovery area in the first flash device Flash corresponding to the first BIOS by the CPLD is passed, the server performs the power-on startup. After the power-on startup of the server fails, the recovery operation is first performed through the core, CPLD, of the server. If the normal power-on startup of the server might not be realized, the CPLD is notified to forcibly switch the first flash device Flash to the second flash device Flash corresponding to the second BIOS, thereby avoiding the server failing to run normally or experience downtime caused by the damage of the flash device Flash. That is to say, the server is provided with two flash devices Flash, and when there is a problem in one of the flash devices Flash, the server might timely switch to the other flash device Flash to ensure that the server might run normally.

In an embodiment, as shown in FIG. 2, when the verification for the staging area, the active area, and the recovery area in the first flash device Flash corresponding to the first BIOS by the CPLD is passed, acquiring the power-on startup command of the server includes the following steps.

At step 202, when invoking the CPLD to verify the staging area, the active area, and the recovery area in the first flash device Flash corresponding to the first BIOS through hash values Hash, and the verification is passed, the power-on startup command of the server is generated through the CPLD.

The server invokes the CPLD to verify the staging area, the active area, and the recovery area in the first flash device Flash corresponding to the first BIOS through the hash values Hash and determine whether the verification is passed or not. In response to a determination conclusion that the verification is passed, the power-on startup command of the server is generated through the CPLD.

The verification for the staging area, the active area, and the recovery area in the first flash device Flash corresponding to the first BIOS by the CPLD may be performed through the hash values Hash. The hash value Hash is also referred to as a hash function (or a hash algorithm), which is a method for creating a small digital “fingerprint” from any kind of data. Area data of each area may be encrypted and calculated through an encryption algorithm to obtain a hash value corresponding to each area. The CPLD may verify the hash values of the areas in the first flash device Flash corresponding to the first BIOS, and when the verification is passed, it indicates that area data of the first flash device Flash corresponding to the first BIOS is secure. Therefore, the CPLD generates the power-on startup command of the server to enable the server to start up and run.

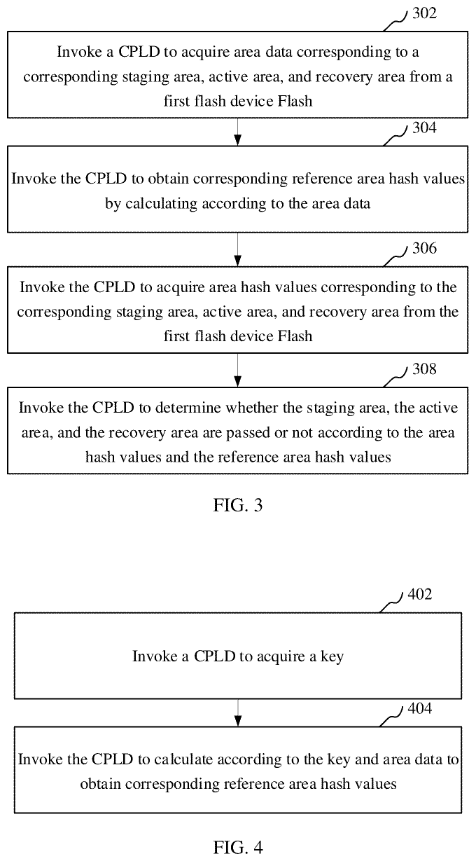

In an embodiment, as shown in FIG. 3, invoking the CPLD to verify the staging area, the active area, and the recovery area in the first flash device Flash corresponding to the first BIOS through the hash values Hash includes the following steps.

At step 302, the CPLD is invoked to acquire area data corresponding to the corresponding staging area, active area, and recovery area from the first flash device Flash.

At step 304, the CPLD is invoked to obtain corresponding reference area hash values by calculating according to the area data.

The CPLD, as the core firmware in the PFR server, may acquire the area data corresponding to the corresponding staging area, active area, and recovery area from the first flash device Flash. The CPLD encrypts and calculates the acquired area data, and the area data may be encrypted and calculated using an encryption algorithm to obtain reference area hash values corresponding to the areas.

The reference area hash values here are standard area hash values corresponding to the staging area, the active area, and the recovery area in the first flash device Flash and are used for verifying the standard area hash values of the staging area, the active area, and the recovery area in the first flash device Flash.

At step 306, the CPLD is invoked to acquire area hash values corresponding to the corresponding staging area, active area, and recovery area from the first flash device Flash.

At step 308, the CPLD is invoked to determine whether the verification for the staging area, the active area, and the recovery area is passed or not according to the area hash values and the reference area hash values.

The area hash values here are hash values calculated by the staging area, the active area, and the recovery area in the first flash device Flash, and it may be verified whether corresponding areas are passed or not through the area hash values and the corresponding reference area hash values. In some embodiments, the CPLD acquires the area hash values corresponding to the corresponding staging area, active area, and recovery area from the first flash device Flash and compares the area hash values corresponding to the staging area, the active area, and the recovery area with corresponding reference area hash values to determine verification results of the staging area, the active area, and the recovery area.

In an embodiment, as shown in FIG. 4, invoking the CPLD to obtain the corresponding reference area hash values by calculating according to the area data includes the following steps.

At step 402, the CPLD is invoked to acquire a key.

At step 404, the CPLD is invoked to calculate according to the key and the area data to obtain the corresponding reference area hash values.

The key is a tool for encrypting and decrypting data, and the key here is a tool for encrypting the area data. The key may also be understood as an encryption algorithm, and the encryption of the area data may be realized through the key so as to obtain encrypted data.

In some embodiments, the CPLD acquires the key. The key may be preset and may also be obtained by determining according to actual service requirements, actual product requirements, or actual application scenarios. The CPLD encrypts and calculates the area data corresponding to the staging area, the active area, and the recovery area in the first flash device Flash of the first BIOS through the key to obtain the reference area hash values corresponding to the staging area, the active area, and the recovery area. The reference area hash values here are used for determining whether the area data corresponding to the staging area, the active area, and the recovery area has been tampered with or damaged.

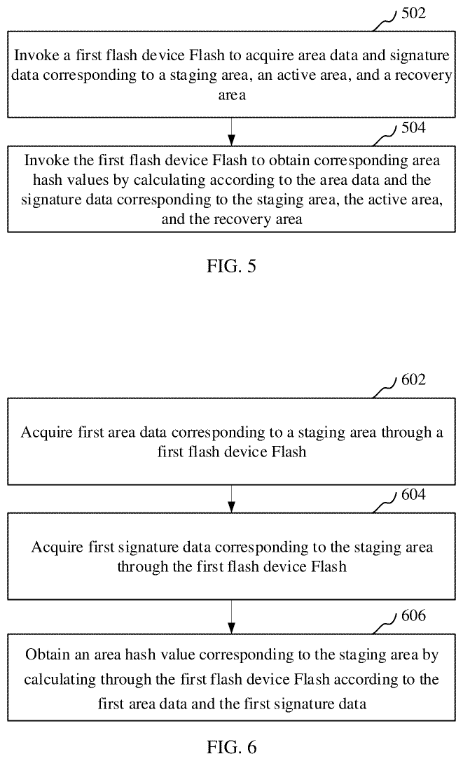

In an embodiment, as shown in FIG. 5, invoking the CPLD to acquire the area hash values corresponding to the corresponding staging area, active area, and recovery area from the first flash device Flash includes the following steps.

At step 502, the first flash device Flash is invoked to acquire the area data and signature data corresponding to the staging area, the active area, and the recovery area.

At step 504, the first flash device Flash is invoked to obtain the corresponding area hash values by calculating according to the area data and the signature data corresponding to the staging area, the active area, and the recovery area.

The area hash values corresponding to the areas in the first flash device Flash are area hash values obtained by encrypting and calculating according to the area data and the signature data by the areas. The area data is all the stored data in the areas, the signature data is data related to an area signature certificate, and the signature data corresponding to different areas is different. The area data and the signature data are encrypted and calculated using an encryption algorithm so as to obtain the corresponding area hash values.

Therefore, the staging area, the active area, and the recovery area in the first flash device Flash may perform encryption calculations according to corresponding area data and signature data in advance to obtain the corresponding area hash values, and the corresponding area hash values may be stored in the first flash device Flash. When the CPLD verifies subsequently, the area hash values corresponding to the staging area, the active area, and the recovery area may be acquired from the first flash device Flash.

In an embodiment, as shown in FIG. 6, the above-mentioned method further includes the following steps.

At step 602, first area data corresponding to the staging area is acquired through the first flash device Flash.

At step 604, first signature data corresponding to the staging area is acquired through the first flash device Flash.

At step 606, the area hash value corresponding to the staging area is obtained by calculating through the first flash device Flash according to the first area data and the first signature data.

Each area of the first flash device Flash corresponds to area data and signature data, and the corresponding area hash value may be obtained by calculating according to the area data and the signature data corresponding to each region and stored in the first flash device Flash.

In some embodiments, the first flash device Flash acquires the first area data and the first signature data corresponding to the staging area Staging, performs an encryption calculation on the first area data and the first signature data according to a preset encryption algorithm to obtain the area hash value corresponding to the staging area Staging, and stores the area hash value in the first flash device Flash.

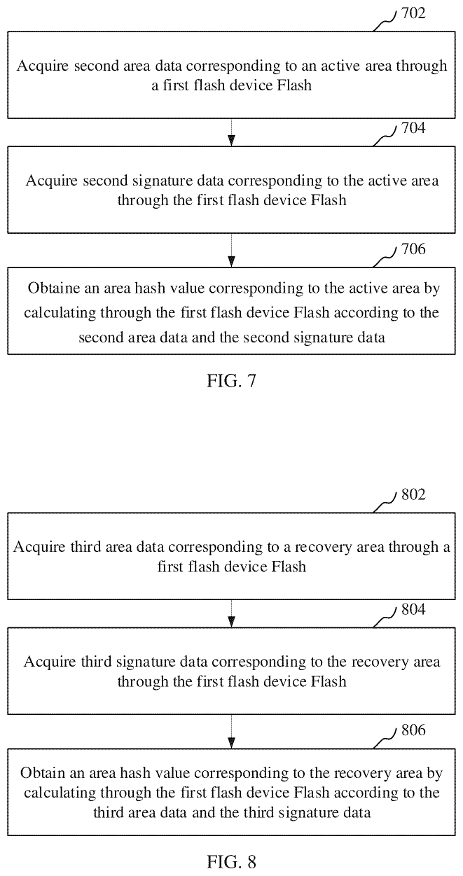

In an embodiment, as shown in FIG. 7, the above-mentioned method further includes the following steps.

At step 702, second area data corresponding to the active area is acquired through the first flash device Flash.

At step 704, second signature data corresponding to the active area is acquired through the first flash device Flash.

At step 706, the area hash value corresponding to the active area is obtained by calculating through the first flash device Flash according to the second area data and the second signature data.

In some embodiments, the first flash device Flash acquires the second area data and the second signature data corresponding to the active area Active, performs an encryption calculation on the second area data and the second signature data according to a preset encryption algorithm to obtain the area hash value corresponding to the active area Active, and stores the area hash value in the first flash device Flash. In an embodiment, as shown in FIG. 8, the above-mentioned method further includes the following steps.

At step 802, third area data corresponding to the recovery area is acquired through the first flash device Flash.

At step 804, third signature data corresponding to the recovery area is acquired through the first flash device Flash.

At step 806, the area hash value corresponding to the recovery area is obtained by calculating through the first flash device Flash according to the third area data and the third signature data.

In some embodiments, the first flash device Flash acquires the third area data and the third signature data corresponding to the recovery area Recovery, performs an encryption calculation on the third area data and the third signature data according to a preset encryption algorithm to obtain the area hash value corresponding to the recovery area Recovery, and stores the area hash value in the first flash device Flash.

In an embodiment, determining whether the verification for the staging area, the active area, and the recovery area is passed or not according to the area hash values and the reference area hash values includes:
when determining that the staging area, the active area, and the recovery area are matched according to the area hash values and the reference area hash values, determining that the verification is passed.

The CPLD obtains the area hash values corresponding to the areas from the first flash device Flash, and then determines verification passing results by comparing matching results of the area hash values and the corresponding reference area hash values. In some embodiments, the CPLD matches the area hash values and the corresponding reference area hash values. The matching may be, for example, whether the area hash value and the reference area hash value are the same. Further, if the area hash values and the corresponding reference area hash values are successfully matched, it is determined as pass, and if any area hash value and the corresponding reference area hash value are not successfully matched, it is determined as not pass.

In an embodiment, performing the power-on startup of the server according to the power-on startup command of the server includes: performing the power-on startup of the server according to the power-on startup command of the server, and running a main program on the server.

The power-on startup command of the server is used for commanding the server to perform power-on startup. After the CPLD is triggered to generate the power-on startup command of the server, the server may perform the power-on startup according to the power-on startup command of the server and run the main program on the server. At this time, the time of the power-on startup of the server will be recorded, and whether the power-on startup of the server is successful is determined through the time of the power-on startup of the server. The main program is a primary program in the server, and whether the power-on startup of the server is successful may be determined by whether the main program runs successfully.

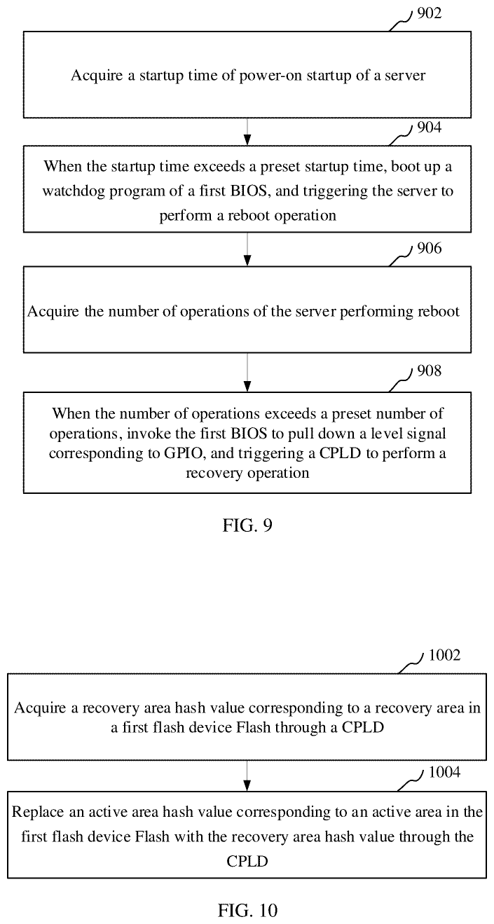

In an embodiment, as shown in FIG. 9, when the power-on startup of the server is not successful, triggering the CPLD to perform the recovery operation includes the following steps.

At step 902, a startup time of the power-on startup of the server is acquired.

At step 904, when the startup time exceeds a preset startup time, a watchdog program of the first BIOS is booted up, and the server is triggered to perform a reboot operation.

When the server performs the power-on startup, it records the startup time of the power-on startup of the server and determines whether the power-on startup of the server is successful through the startup time of the power-on startup of the server. In some embodiments, a recorded startup time of the power-on startup of the server and the preset startup time are acquired, and the startup time of the power-on startup of the server is compared with the preset startup time to determine whether the power-on startup of the server is successful. For example, when the startup time of the power-on startup of the server exceeds the preset startup time, it indicates that there is a problem in the server, and the power-on startup is not successful. Then, the watchdog program of the first BIOS may be started, and the server is triggered to perform the reboot operation. The preset startup time may be obtained by presetting according to actual service requirements, actual product requirements, or actual application scenarios. For example, the preset startup time is 6 minutes.

The watchdog program here is a program used for triggering the server to perform a reboot operation, and the server may perform an attempt reboot operation by running the watchdog program.

On the contrary, when the startup time of the power-on startup of the server does not exceed the preset startup time, it indicates that there is no problem on the power-on startup of the server, the server runs normally, and the main program on the server also runs normally.

At step 906, the number of operations of the server performing reboot is acquired. At step 908, when the number of operations exceeds a preset number of operations, the first BIOS is invoked to pull down a level signal corresponding to GPIO, and the CPLD is triggered to perform the recovery operation.

Since the server does not necessarily boot up successfully when performing a reboot operation, the number of operations of the server performing reboot may be recorded, and whether the server boots up successfully may be determined according to the number of reboot operations. In some embodiments, the number of operations of the server performing reboot and the preset number of operations are acquired, and whether the reboot of the server is successful is determined by comparing the number of reboot operations with the preset number of operations. For example, when the number of reboot operations exceeds the preset number of operations, it indicates that the server does not boot up successfully after a plurality of reboot operations. Thus, the normal running of the server might not be realized through reboot, and the CPLD may be used to try to boot up the server. In some embodiments, the first BIOS pulls down the level signal corresponding to the GPIO, and the CPLD is triggered to perform the recovery operation.

The preset number of operations may be obtained by determining according to actual service requirements, actual product requirements, or actual application scenarios. For example, the preset number of operations may be 5.

On the contrary, when the number of reboot operations does not exceed the preset number of operations, it indicates that the problem of the server failing to run normally may be solved by the server trying to reboot several times.

In an embodiment, as shown in FIG. 10, triggering the CPLD to perform the recovery operation includes the following steps.

At step 1002, a recovery area hash value corresponding to the recovery area in the first flash device Flash is acquired through the CPLD.

At step 1004, an active area hash value corresponding to the active area in the first flash device Flash is replaced with the recovery area hash value through the CPLD.

The recovery operation of the CPLD is to recover the recovery area hash value in the recovery area Recovery into the active area Active and then reboot. In some embodiments, The CPLD acquires the recovery area hash value corresponding to the recovery area Recovery in the first flash device Flash, replaces the recovery area hash value with the active area hash value corresponding to the active area Active for rebooting. At this time, the number of recovery operations of the CPLD is recorded, and it is determined whether the problem of the server failing to run normally may be solved through the recovery operations of the CPLD according to the number of recovery operations of the CPLD.

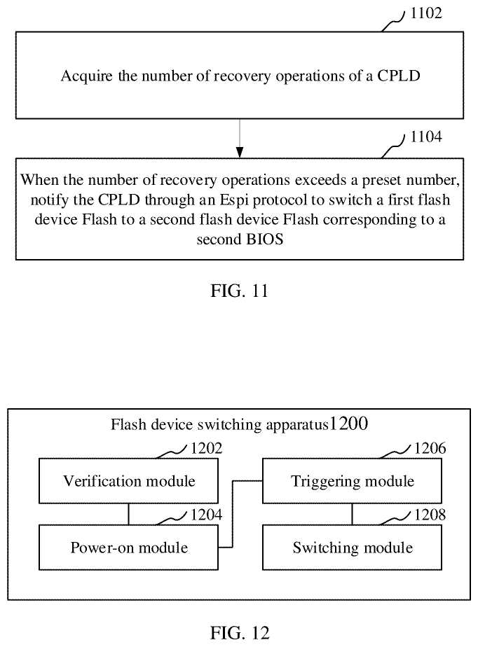

In an embodiment, as shown in FIG. 11, after the recovery operation of the CPLD fails, notifying the CPLD to switch the first flash device Flash to the second flash device Flash corresponding to the second BIOS includes the following steps.

At step 1102, the number of recovery operations of the CPLD is acquired.

At step 1104, when the number of recovery operations exceeds a preset number, the CPLD is notified through an Espi protocol to switch the first flash device Flash to the second flash device Flash corresponding to the second BIOS.

In some embodiments, the number of recovery operations of the CPLD and the preset number are acquired, and it is determined whether the server may realize normal running through the recovery operations of the CPLD by comparing the number of recovery operations with the preset number. For example, when the number of recovery operations exceeds the preset number, it indicates that the server might not realize normal running through the recovery operations of the CPLD. Thus, in order to avoid the server failing to run normally or experience downtime caused by the damage of the first flash device Flash of the first BIOS, the CPLD is notified through the Espi protocol to switch the first flash device Flash to the second flash device Flash corresponding to the second BIOS, and the second flash device Flash corresponding to the second BIOS is used to replace the first flash device Flash corresponding to the first BIOS for working, thereby ensuring that the server may run normally or not experience downtime.

In an embodiment, the CPLD has a PFR function.

In an embodiment, the server has a PFR function.

In an embodiment, the first BIOS has a PFR function.

In an embodiment, the second BIOS has a PFR function.

Since the server has the PFR function, the firmware CPLD in the server also has a PFR function. The first BIOS has the PFR function, the second BIOS has the PFR function, and the server has the PFR function, thereby well avoiding the risk of firmware tampering.

In a specific application scenario, for example, the application scenario may be a double Flash-based PFR BIOS bootup verification scenario and in some embodiments includes the following steps.

At S11, the CPLD verifies the Staging area, the Active area, and the Recovery area of the PFR BIOS through Hash values.

At S12, when verification for the Hash values is passed, power-on startup of the server is performed, and the main program is booted up to run.

At S13, if the startup time exceeds 6 minutes, the watchdog program of the BIOS is booted up, and the server is triggered to reboot.

At S14, if the number of reboots exceeds 5, the BIOS pulls down the corresponding GPIO pin, and the CPLD is triggered to perform Recovery again.

At S15, if the CPLD does Recovery more than three times and the server continues to reboot, the CPLD is notified through the Espi protocol to switch the Flash forcibly.

It should be understood that, although the various steps in the above-mentioned flowcharts are shown sequentially as indicated by the arrows, these steps are not necessarily performed sequentially in the order indicated by the arrows. These steps are performed in no strict order unless explicitly stated herein, and these steps may be performed in other orders. Moreover, at least some of the steps in the above-described flowcharts may include multiple sub-steps or stages that are not necessarily performed at the same time, but may be performed at different times, and the order in which these sub-steps or stages are performed is not necessarily sequential, but may be performed in turn or in alternation with other steps or at least some of the sub-steps or stages of other steps.

In an embodiment, as shown in FIG. 12, a Flash device switching apparatus 1200 is provided. The apparatus is applied to a server, and the server includes a CPLD, a first BIOS, and a second BIOS. The first BIOS and the second BIOS include corresponding flash devices Flash, and the flash device Flash includes a staging area, an active area, and a recovery area. The apparatus includes: a verification module 1202, a power-on module 1204, a triggering module 1206, and a switching module 1208.

The verification module 1202 is configured to, when verification for the staging area, the active area, and the recovery area in a first flash device Flash corresponding to the first BIOS by the CPLD is passed, acquire a power-on startup command of the server.

The power-on module 1204 is configured to perform power-on startup of the server according to the power-on startup command of the server.

The triggering module 1206 is configured to, when the power-on startup of the server is not successful, trigger the CPLD to perform a recovery operation.

The switching module 1208 is configured to, after the recovery operation of the CPLD fails, notify the CPLD to switch the first flash device Flash to a second flash device Flash corresponding to the second BIOS.

In an embodiment, the verification module 1202 is configured to invoke the CPLD to verify whether the staging area, the active area, and the recovery area in the first flash device Flash corresponding to the first BIOS are passed or not through hash values Hash and when the verification is passed, invoke the CPLD to generate the power-on startup command of the server.

In an embodiment, the verification module 1202 is configured to invoke the CPLD to acquire area data corresponding to the corresponding staging area, active area, and recovery area from the first flash device Flash, invoke the CPLD to obtain corresponding reference area hash values by calculating according to the area data, invoke the CPLD to acquire area hash values corresponding to the corresponding staging area, active area, and recovery area from the first flash device Flash, and invoke the CPLD to determine whether the staging area, the active area, and the recovery area are passed or not according to the area hash values and the reference area hash values.

In an embodiment, the verification module 1202 is configured to invoke the CPLD to acquire a key and invoke the CPLD to calculate according to the key and the area data to obtain the corresponding reference area hash values.

In an embodiment, the verification module 1202 is configured to invoke the first flash device Flash to acquire the area data and signature data corresponding to the staging area, the active area, and the recovery area and invoke the first flash device Flash to obtain the corresponding area hash values by calculating according to the area data and the signature data corresponding to the staging area, the active area, and the recovery area.

In an embodiment, the verification module 1202 is configured to acquire first area data corresponding to the staging area through the first flash device Flash, acquire first signature data corresponding to the staging area through the first flash device Flash, and obtain the area hash value corresponding to the staging area by calculating through the first flash device Flash according to the first area data and the first signature data.

In an embodiment, the verification module 1202 is configured to acquire second area data corresponding to the active area through the first flash device Flash, acquire second signature data corresponding to the active area through the first flash device Flash, and obtain the area hash value corresponding to the active area by calculating through the first flash device Flash according to the second area data and the second signature data.

In an embodiment, the verification module 1202 is configured to acquire third area data corresponding to the recovery area through the first flash device Flash, acquire third signature data corresponding to the recovery area through the first flash device Flash, and obtain the area hash value corresponding to the recovery area by calculating through the first flash device Flash according to the third area data and the third signature data.

In an embodiment, the verification module 1202 is configured to invoke the CPLD to determine whether the staging area, the active area, and the recovery area are matched according to the area hash values and the reference area hash values, and determine whether to pass.

In an embodiment, the power-on module 1204 is configured to perform the power-on startup of the server according to the power-on startup command of the server and run a main program on the server.

In an embodiment, the triggering module 1206 is configured to acquire a startup time of the power-on startup of the server; when the startup time exceeds a preset startup time, boot up a watchdog program of the first BIOS, and trigger the server to perform a reboot operation; acquire the number of operations of the server performing reboot; and when the number of operations exceeds a preset number of operations, invoke the first BIOS to pull down a level signal corresponding to GPIO, and trigger the CPLD to perform the recovery operation.

In an embodiment, the triggering module 1206 is configured to acquire a recovery area hash value corresponding to the recovery area in the first flash device Flash through the CPLD and replace an active area hash value corresponding to the active area in the first flash device Flash with the recovery area hash value through the CPLD.

In an embodiment, the switching module 1208 is configured to acquire the number of recovery operations of the CPLD, and when the number of recovery operations exceeds a preset number, notify the CPLD through an Espi protocol to switch the first flash device Flash to the second flash device Flash corresponding to the second BIOS. In an embodiment, the CPLD has a PFR function.

In an embodiment, the server has a PFR function.

In an embodiment, the first BIOS has a PFR function.

In an embodiment, the second BIOS has a PFR function.

With regard to the specific definition of the Flash device switching apparatus, reference might be made to the above definition of the Flash device switching method, which will not be repeated here. The various modules in the above-mentioned Flash device switching apparatus may be implemented in whole or in part by software, hardware, and a combination of the two. The above-mentioned modules may be embedded in the form of hardware or stored separately from the processor in the computer device, or may be stored in the form of software in the memory of the computer device, facilitating the processor to invoke the above-mentioned modules to perform the corresponding operations.

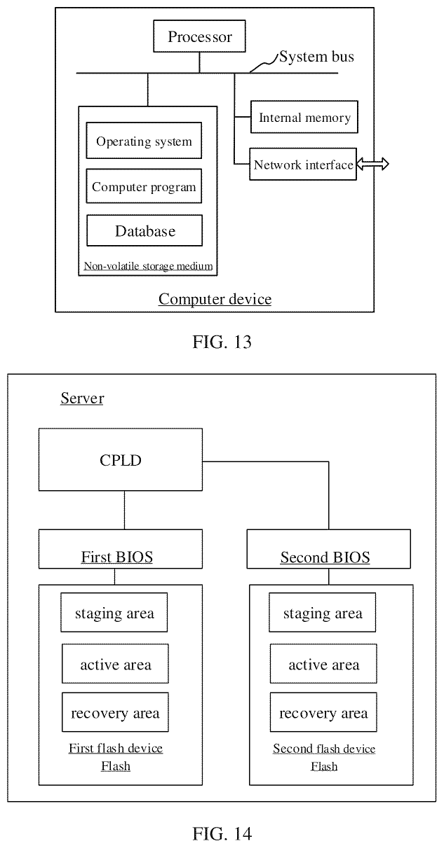

In an embodiment, a computer device is provided. The computer device may be a server, and its internal structure may be shown in FIG. 13. The computer device includes a processor, a memory, and a network interface connected through a system bus. The processor of the computer device is configured to provide calculation and control capabilities. The memory of the computer device includes a non-volatile storage medium and an internal memory. The non-volatile storage medium stores an operating system and a computer program. The internal memory provides an environment for running the operating system and the computer program in the non-volatile storage medium. The network interface of the computer device is configured to communicate with an external terminal through a network connection. The computer program, when executed by the processor, implements the Flash device switching method.

It will be appreciated by a person skilled in the art that the structure shown in FIG. 13 is merely a block diagram of a portion of the structure relevant to the solution of the present application and does not constitute a limitation on the computer device to which the solution of the present application is applied. A specific computer device may include more or less components than those shown in the drawings, a combination of certain components, or have a different arrangement of components.

In an embodiment, a computer device is provided, including at least one memory and processor, the memory having stored therein computer-readable instructions which, when executed by one or more processors, cause the one or more processors to perform the steps of:
when verification for a staging area, an active area, and a recovery area in a first flash device Flash corresponding to a first BIOS by the CPLD is passed, acquiring a power-on startup command of a server;
performing power-on startup of the server according to the power-on startup command of the server;
when the power-on startup of the server is not successful, triggering the CPLD to perform a recovery operation; and
after the recovery operation of the CPLD fails, notifying the CPLD to switch the first flash device Flash to a second flash device Flash corresponding to the second BIOS.

In an embodiment, the processor further implements the following steps when executing the computer program:
invoking the CPLD to verify whether the staging area, the active area, and the recovery area in the first flash device Flash corresponding to the first BIOS are passed or not through hash values Hash; and
when the verification is passed, invoking the CPLD to generate the power-on startup command of the server.

In an embodiment, the processor further implements the following steps when executing the computer program:
invoking the CPLD to acquire area data corresponding to the corresponding staging area, active area, and recovery area from the first flash device Flash;
invoking the CPLD to obtain corresponding reference area hash values by calculating according to the area data;
invoking the CPLD to acquire area hash values corresponding to the corresponding staging area, active area, and recovery area from the first flash device Flash; and
invoking the CPLD to determine whether the staging area, the active area, and the recovery area are passed or not according to the area hash values and the reference area hash values.

In an embodiment, the processor further implements the following steps when executing the computer program:
invoking the CPLD to acquire a key; and
invoking the CPLD to calculate according to the key and the area data to obtain the corresponding reference area hash values.

In an embodiment, the processor further implements the following steps when executing the computer program:

invoking the first flash device Flash to acquire the area data and signature data corresponding to the staging area, the active area, and the recovery area; and

invoking the first flash device Flash to obtain the corresponding area hash values by calculating according to the area data and the signature data corresponding to the staging area, the active area, and the recovery area.

In an embodiment, the processor further implements the following steps when executing the computer program:
acquiring first area data corresponding to the staging area through the first flash device Flash;
acquiring first signature data corresponding to the staging area through the first flash device Flash; and
obtaining the area hash value corresponding to the staging area by calculating through the first flash device Flash according to the first area data and the first signature data.

In an embodiment, the processor further implements the following steps when executing the computer program:
acquiring second area data corresponding to the active area through the first flash device Flash;
acquiring second signature data corresponding to the active area through the first flash device Flash; and
obtaining the area hash value corresponding to the active area by calculating through the first flash device Flash according to the second area data and the second signature data.

In an embodiment, the processor further implements the following steps when executing the computer program:
acquiring third area data corresponding to the recovery area through the first flash device Flash;
acquiring third signature data corresponding to the recovery area through the first flash device Flash; and
obtaining the area hash value corresponding to the recovery area by calculating through the first flash device Flash according to the third area data and the third signature data.

In an embodiment, the processor further implements the following steps when executing the computer program:
invoking the CPLD to determine whether the staging area, the active area, and the recovery area are matched according to the area hash values and the reference area hash values, and determining whether to pass.

In an embodiment, the processor further implements the following steps when executing the computer program:
performing the power-on startup of the server according to the power-on startup command of the server, and running a main program on the server.

In an embodiment, the processor further implements the following steps when executing the computer program:
acquiring a startup time of the power-on startup of the server;
when the startup time exceeds a preset startup time, booting up a watchdog program of the first BIOS, and triggering the server to perform a reboot operation;
acquiring the number of operations of the server performing reboot; and
when the number of operations exceeds a preset number of operations, invoking the first BIOS to pull down a level signal corresponding to GPIO, and triggering the CPLD to perform the recovery operation.

In an embodiment, the processor further implements the following steps when executing the computer program:
acquiring a recovery area hash value corresponding to the recovery area in the first flash device Flash through the CPLD; and
replacing an active area hash value corresponding to the active area in the first flash device Flash with the recovery area hash value through the CPLD.

In an embodiment, the processor further implements the following steps when executing the computer program:
acquiring the number of recovery operations of the CPLD; and
when the number of recovery operations exceeds a preset number, notifying the CPLD through an Espi protocol to switch the first flash device Flash to the second flash device Flash corresponding to the second BIOS.

In an embodiment, the CPLD has a PFR function.

In an embodiment, the server has a PFR function.

In an embodiment, the first BIOS has a PFR function.

In an embodiment, the second BIOS has a PFR function.

In an embodiment, a non-volatile computer-readable storage medium is provided, the non-volatile computer-readable storage medium storing computer-readable instructions which, when executed by a processor, implement the following steps: when verification for a staging area, an active area, and a recovery area in a first flash device Flash corresponding to a first BIOS by the CPLD is passed, acquiring a power-on startup command of a server;
performing power-on startup of the server according to the power-on startup command of the server;
when the power-on startup of the server is not successful, triggering the CPLD to perform a recovery operation; and
after the recovery operation of the CPLD fails, notifying the CPLD to switch the first flash device Flash to a second flash device Flash corresponding to the second BIOS.

In an embodiment, the processor further implements the following steps when executing the computer program:
invoking the CPLD to verify whether the staging area, the active area, and the recovery area in the first flash device Flash corresponding to the first BIOS are passed or not through hash values Hash; and
when the verification is passed, invoking the CPLD to generate the power-on startup command of the server.

In an embodiment, the processor further implements the following steps when executing the computer program:
invoking the CPLD to acquire area data corresponding to the corresponding staging area, active area, and recovery area from the first flash device Flash;
invoking the CPLD to obtain corresponding reference area hash values by calculating according to the area data;
invoking the CPLD to acquire area hash values corresponding to the corresponding staging area, active area, and recovery area from the first flash device Flash; and
invoking the CPLD to determine whether the staging area, the active area, and the recovery area are passed or not according to the area hash values and the reference area hash values.

In an embodiment, the processor further implements the following steps when executing the computer program:
invoking the CPLD to acquire a key; and
invoking the CPLD to calculate according to the key and the area data to obtain the corresponding reference area hash values.

In an embodiment, the processor further implements the following steps when executing the computer program:
invoking the first flash device Flash to acquire the area data and signature data corresponding to the staging area, the active area, and the recovery area; and
invoking the first flash device Flash to obtain the corresponding area hash values by calculating according to the area data and the signature data corresponding to the staging area, the active area, and the recovery area.

In an embodiment, the processor further implements the following steps when executing the computer program:
acquiring first area data corresponding to the staging area through the first flash device Flash;
acquiring first signature data corresponding to the staging area through the first flash device Flash; and
obtaining the area hash value corresponding to the staging area by calculating through the first flash device Flash according to the first area data and the first signature data.

In an embodiment, the processor further implements the following steps when executing the computer program:
acquiring second area data corresponding to the active area through the first flash device Flash;
acquiring second signature data corresponding to the active area through the first flash device Flash; and
obtaining the area hash value corresponding to the active area by calculating through the first flash device Flash according to the second area data and the second signature data.

In an embodiment, the processor further implements the following steps when executing the computer program:
acquiring third area data corresponding to the recovery area through the first flash device Flash;
acquiring third signature data corresponding to the recovery area through the first flash device Flash; and
obtaining the area hash value corresponding to the recovery area by calculating through the first flash device Flash according to the third area data and the third signature data.

In an embodiment, the processor further implements the following steps when executing the computer program:
invoking the CPLD to determine whether the staging area, the active area, and the recovery area are matched according to the area hash values and the reference area hash values, and determining whether to pass.

In an embodiment, the processor further implements the following steps when executing the computer program:
performing the power-on startup of the server according to the power-on startup command of the server, and running a main program on the server.

In an embodiment, the processor further implements the following steps when executing the computer program:
acquiring a startup time of the power-on startup of the server;
when the startup time exceeds a preset startup time, booting up a watchdog program of the first BIOS, and triggering the server to perform a reboot operation;
acquiring the number of operations of the server performing reboot; and
when the number of operations exceeds a preset number of operations, invoking the first BIOS to pull down a level signal corresponding to GPIO, and triggering the CPLD to perform the recovery operation.

In an embodiment, the processor further implements the following steps when executing the computer program:
acquiring a recovery area hash value corresponding to the recovery area in the first flash device Flash through the CPLD; and
replacing an active area hash value corresponding to the active area in the first flash device Flash with the recovery area hash value through the CPLD.

In an embodiment, the processor further implements the following steps when executing the computer program:
acquiring the number of recovery operations of the CPLD; and
when the number of recovery operations exceeds a preset number, notifying the CPLD through an Espi protocol to switch the first flash device Flash to the second flash device Flash corresponding to the second BIOS.

In an embodiment, the CPLD has a PFR function.

In an embodiment, the server has a PFR function.

In an embodiment, the first BIOS has a PFR function.

In an embodiment, the second BIOS has a PFR function.

It will be appreciated by a person skilled in the art that implementing all or part of the flow of the methods of the above-mentioned embodiments may be accomplished by instructing the relevant hardware through the computer program. The above-mentioned computer program may be stored on a non-volatile computer-readable storage medium and may include the flow of the above-mentioned method embodiments when executed. Any reference to the memory, storage, databases, or other media used in embodiments provided by the present application may include a non-volatile and/or volatile memory. The non-volatile memory may include a read only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration and not limitation, the RAM are available in many forms, such as a static RAM (SRAM), a dynamic RAM (DRAM), a synchronous DRAM (SDRAM), a double data rate SDRAM (DDRSDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM).

The technical features of the above embodiments may be combined arbitrarily. In order to make the description concise, not all possible combinations of the technical features of the above-mentioned embodiments are described. However, as long as there is no contradiction between the combinations of these technical features, they shall be considered to be within the scope of this specification.

The above embodiments express only several implementations of the present application, which are described in a relatively specific and detailed manner, but are not to be construed as a limitation of the patent scope. It should be noted that several changes and modifications may be made by a person skilled in the art without departing from the concept of the present application, and these changes and modifications fall within the scope of the present application. Therefore, the scope of the patent application shall be subject to the attached claims.

What is claimed is:

1. A Flash device switching method, being applied to a server, the server comprising a controller, a first basic input/output system (BIOS), and a second BIOS, wherein the first BIOS and the second BIOS correspond to corresponding flash devices, and the flash device comprises a staging area, an active area, and a recovery area, wherein the method comprises:
when verification for the staging area, the active area, and the recovery area in a first flash device corresponding to the first BIOS by the controller is passed, acquiring a power-on startup command of the server;
performing power-on startup of the server according to the power-on startup command of the server;
when the power-on startup of the server is not successful, triggering the controller to perform a recovery operation; and
after the recovery operation of the controller fails, notifying the controller to switch the first flash device to a second flash device corresponding to the second BIOS.

2. The method according to claim 1, wherein the when verification for the staging area, the active area, and the recovery area in the first flash device corresponding to the first BIOS by the controller is passed, acquiring the power-on startup command of the server comprises:
invoking the controller to verify whether the staging area, the active area, and the recovery area in the first flash device corresponding to the first BIOS are passed or not through hash values; and
when the verification is passed, generating the power-on startup command of the server through the controller.

3. The method according to claim 2, wherein the invoking the controller to verify whether the staging area, the active area, and the recovery area in the first flash device corresponding to the first BIOS are passed or not through the hash values comprises:
invoking the controller to acquire area data corresponding to the staging area, the active area, and the recovery area from the first flash device;
invoking the controller to obtain corresponding reference area hash values by calculating according to the area data;
invoking the controller to acquire area hash values corresponding to the staging area, the active area, and the recovery area from the first flash device; and
invoking the controller to determine whether the verification for the staging area, the active area, and the recovery area is passed or not according to the area hash values and the reference area hash values.

4. The method according to claim 3, wherein the invoking the controller to obtain the corresponding reference area hash values by calculating according to the area data comprises:
invoking the controller to acquire a key; and
invoking the controller to calculate according to the key and the area data to obtain the corresponding reference area hash values.

5. The method according to claim 3, wherein the invoking the controller to acquire the area hash values corresponding to the staging area, the active area, and the recovery area from the first flash device comprises:
invoking the first flash device to acquire the area data and signature data corresponding to the staging area, the active area, and the recovery area; and
invoking the first flash device to obtain the corresponding area hash values by calculating according to the area data and the signature data corresponding to the staging area, the active area, and the recovery area.

6. The method according to claim 5, further comprising:
acquiring first area data corresponding to the staging area through the first flash device;
acquiring first signature data corresponding to the staging area through the first flash device; and
obtaining the area hash value corresponding to the staging area by calculating through the first flash device according to the first area data and the first signature data.

7. The method according to claim 5, further comprising:
acquiring second area data corresponding to the active area through the first flash device;
acquiring second signature data corresponding to the active area through the first flash device; and
obtaining the area hash value corresponding to the active area by calculating through the first flash device according to the second area data and the second signature data.

8. The method according to claim 5, further comprising:
acquiring third area data corresponding to the recovery area through the first flash device;
acquiring third signature data corresponding to the recovery area through the first flash device; and
obtaining the area hash value corresponding to the recovery area by calculating through the first flash device according to the third area data and the third signature data.

9. The method according to claim 3, wherein the invoking the controller to determine whether the verification for the staging area, the active area, and the recovery area is passed or not according to the area hash values and the reference area hash values comprises:
when invoking the controller to determine that the staging area, the active area, and the recovery area are matched according to the area hash values and the reference area hash values, determining that the verification for the staging area, the active area, and the recovery area is passed.

10. The method according to claim 9, wherein the invoking the controller to determine whether the verification for the staging area, the active area, and the recovery area is passed or not according to the area hash values and the reference area hash values comprises:
when invoking the controller to determine that the staging area, the active area, and the recovery area are not matched according to the area hash values and the reference area hash values, determining that the staging area, the active area, and the recovery area are not passed.

11. The method according to claim 1, wherein the performing the power-on startup of the server according to the power-on startup command of the server comprises:
performing the power-on startup of the server according to the power-on startup command of the server, and running a main program on the server.

12. The method according to claim 1, wherein the when the power-on startup of the server is not successful, triggering the controller to perform the recovery operation comprises:
acquiring a startup time of the power-on startup of the server;
when the startup time exceeds a preset startup time, booting up a watchdog program of the first BIOS, and triggering the server to perform a reboot operation;
acquiring a number of operations of the server performing reboot; and
when the number of operations exceeds a preset number of operations, invoking the first BIOS to pull down a level signal corresponding to general-purpose input/output (GPIO), and triggering the controller to perform the recovery operation.

13. The method according to claim 12, further comprising:
when the startup time does not exceed the preset startup time, running the server normally.

14. The method according to claim 12, further comprising:
when the number of operations does not exceed the preset number of operations, performing reboot multiple times through the server.

15. The method according to claim 1, wherein the triggering the controller to perform the recovery operation comprises:
acquiring a recovery area hash value corresponding to the recovery area in the first flash device through the controller; and
replacing an active area hash value corresponding to the active area in the first flash device with the recovery area hash value through the controller.

16. The method according to claim 1, wherein the after the recovery operation of the controller fails, notifying the controller to switch the first flash device to the second flash device corresponding to the second BIOS comprises:
acquiring a number of recovery operations of the controller; and
when the number of recovery operations exceeds a preset number, notifying the controller through an enhanced serial peripheral interface (eSPI) protocol to switch the first flash device to the second flash device corresponding to the second BIOS.

17. The method according to claim 1, wherein the server, the controller, the first BIOS, and the second BIOS all have a platform firmware resilience (PFR) function.

18. A computer device, comprising a memory and one or more processors, the memory having stored therein computer-readable instructions which, when executed by the one or more processors, cause the one or more processors to perform a Flash device switching method being applied to a server, the server comprising a controller, a first basic input/output system (BIOS), and a second BIOS, wherein the first BIOS and the second BIOS correspond to corresponding flash devices, and the flash device comprises a staging area, an active area, and a recovery area, wherein the method comprises:
when verification for the staging area, the active area, and the recovery area in a first flash device corresponding to the first BIOS by the controller is passed, acquiring a power-on startup command of the server;
performing power-on startup of the server according to the power-on startup command of the server;
when the power-on startup of the server is not successful, triggering the controller to perform a recovery operation; and
after the recovery operation of the controller fails, notifying the controller to switch the first flash device to a second flash device corresponding to the second BIOS.

19. One or more non-volatile computer-readable storage media storing computer-readable instructions, wherein the computer-readable instructions, when executed by one or more processors, cause the one or more processors to perform a Flash device switching method being applied to a server, the server comprising a controller, a first basic input/output system (BIOS), and a second BIOS, wherein the first BIOS and the second BIOS correspond to corresponding flash devices, and the flash device comprises a staging area, an active area, and a recovery area, wherein the method comprises:
when verification for the staging area, the active area, and the recovery area in a first flash device corresponding to the first BIOS by the controller is passed, acquiring a power-on startup command of the server;
performing power-on startup of the server according to the power-on startup command of the server;
when the power-on startup of the server is not successful, triggering the controller to perform a recovery operation; and
after the recovery operation of the controller fails, notifying the controller to switch the first flash device to a second flash device corresponding to the second BIOS.

20. The method according to claim 1, wherein the staging area is configured to upgrade a temporary buffer region, the active area is configured to store uncompressed and directly executed firmware, and the recovery area is configured to store compressed backup files.
